(19) United States
(12) Patent Application Publication
(10) Pub. No.: US 2011/0003069 A1
(43) Pub. Date: Jan. 6, 2011

(54) Fabrication method of nanomaterials by using polymeric nanoporous templates

(75) Inventors: Rong-Ming Ho, Hsin-Chu (TW); Han-Yu Hsueh, Hsin-Chu (TW); Ming-Shiuan She, Hsin-Chu (TW); Wen-Hsien Tseng, Hsin-Hsien (TW); Chun-Ku Chen, Hsin-Chu (TW); Yeo-Wan Chiang, Hsin-Chu (TW)

Correspondence Address: HUDAK, SHUNK & FARINE, CO., L.P.A., 2020 FRONT STREET, SUITE 307, CUYAHOGA FALLS, OH, 44221, US

(73) Assignee: NATIONAL TSING HUA UNIVERSITY, Hsin-Chu (TW)

(21) Appl. No.: 12/655,342

(22) Filed: Dec. 29, 2009

(30) Foreign Application Priority Data
Jul. 3, 2009 (TW) 098122686

(51) Int. Cl. B05D 5/12; B05D 3/02; B05D 3/06

(52) U.S. Cl. 427/58; 427/227; 427/243

(57) ABSTRACT

A fabrication method of a nanomaterial by using a polymeric nanoporous template is disclosed. First, a block copolymer bulk is made from a block copolymer polymerized from decomposable and undecomposable monomers. By removing the decomposable portion of the block copolymer bulk, the polymeric nanoporous template with a plurality of holes is obtained, and these holes have nanostructures with regular arrangement. By exploiting a nanoreactor concept, a sol-gel process or an electrochemical synthesis, for example, is then carried out within the template such that the holes are filled with various filler materials, such as ceramics, metals and polymers, so as to prepare a nanocomposite material having the nanostructure. After removing the polymeric nanoporous template, the nanomaterial with the nanostructure is manufactured.

### BACKGROUND OF THE INVENTION

1. Field of the Invention

The present invention relates to a fabrication method of a nanomaterial, in particular to a fabrication method of a nanocomposite material and a nanomaterial by using a polymeric nanoporous template.

2. Description of the Related Art

Due to the mutual insolubility of chain segments and the effect of binding chemical bonds of a block copolymer, the block copolymer at a temperature below a specific temperature (which is called the order-disorder transition temperature) will be self-assembled to form an ordered microstructure in a state with minimum Gibbs free energy of thermodynamics. After the microphase separation takes place, a domain-size falls in a neighborhood of tens of nanometers. Therefore, the block copolymer at a temperature below the order-disorder transition temperature will form various nanostructures varied with the volume fraction of constituted block, and the nanostructures can be sphere, hexagonal cylinder, lamellae, bicontinuous (or gyroid) or perforated layer structure. Obviously, the major advantages of a block copolymer resides on the features of a nanoscale size, a diversification, and a periodic nanostructure that allow arrangements in a broad range, and thus such copolymer is very useful in academic and industrial applications.

Various kinds of nanostructures are synthesized and classified using the dimensionality of the nanostructure itself. All kinds of nanomaterials used for structural applications were suggested to build from the constituting elementary units, namely, 0D dots and particles, 1D nanowires and nanotubes, 2D coatings and films, and 3D bulks. A series of related syntheses and applications of inorganic nanostructures catch the world's attention and attract related scholars to do researches in this area. For example, nanowires and inorganic nanobelts were published by Professor Zhong-Lin Wang of Georgia Institute of Technology, wherein the manufacture and property measurement of a device including a sensor or a nanogenerator. It is not difficult to observe the popularity and significance of this field. Inorganic helix nanowires catch people's attention due to its mechanical strength and optical applications. Inorganic nanomaterials and composite materials can be prepared by different ways including a vapor-liquid-solid growth process, or a template having nanoholes and integrated with a chemical vapor deposition, an electrodeposition, or a sol-gel process. In addition, the self-assembly of a surfactant and an inorganic precursor can be synthesized into an inorganic nanowire and its composite material of different structures. However, it is still a challenging research at the present stage to prepare orderly arranged inorganic nanomaterials of different structures.

There are two main methods of producing inorganic nanomaterials of different structures by using a porous template, such as an anodic aluminum oxide (AAO) template and a block copolymer system to fill other different materials. However, the AAO template has holes mostly with a cylinder structure and belongs to a hard material, thereby incurring an inconvenient manufacturing process. At present, a common block copolymer system generally includes a polystyrene-polymethylmethacrylate (PS-PMMA) system and a polystyrene-polyimide (PS-PI) system. The PS-PMMA system is provided for removing the PMMA by an ultraviolet (UV) light to obtain a PS porous template. Due to the penetrability of the ultraviolet light, the larger the thickness, the higher is the difficulty for the ultraviolet light to penetrate and remove the PMMA. Therefore, most of these systems can be made as films. In addition, small molecules remained after the ultraviolet light decomposes the PMMA are removed by a solvent, and such process requires two steps including a dry process and a wet process. The PS-PI system removes PI by ozone. Similarly, this process involves a gas penetrability issue and complicated dry and wet processes, and thus the PS-PI can mostly only be used for the application of a film.

### SUMMARY OF THE INVENTION

It is a primary objective of the present invention to provide a fabrication method of a nanomaterial by using a polymeric nanoporous template to produce a nanocomposite material having a nanostructure in a periodic arrangement and composed of a ceramics/polymer, metal/polymer or polymer/polymer, and organic/inorganic, inorganic/inorganic or organic/organic nanocomposite nanomaterial or an inorganic nanomaterial having a specific nanostructure.

According to the objective of the present invention, a fabrication method of a nanomaterial by using a polymeric nanoporous template is provided, and the method comprises the following steps. The block copolymer composed of at least one decomposable monomer and at least one undecomposable monomer polymerized with one another is used to prepare a block copolymer bulk, and a decomposable portion of the block copolymer bulk forms a plurality of nanostructures in a periodic arrangement. The block copolymer bulk is hydrolyzed selectively to degrade a chain segment of the decomposable portion by an alkaline solution. A polymeric nanoporous template having a plurality of holes can be obtained after removing the decomposable portion. Wherein, the diameter of the holes or the distance between centers of two adjacent holes is equal to 5-50 nm. A filler material is filled into the holes by a so-gel process to obtain a nanocomposite material having the same structure as the block copolymer bulk structure. The polymeric nanoporous template of the nanocomposite material is removed by an ultraviolet (UV) light, a calcination process, an organic solvent or a supercritical fluid to obtain a plurality of nanomaterials with reverse phases and identical to the aforementioned plurality of nanostructures.

Wherein, the decomposable monomer is selected form the group consisting of L-lactide, D-lactide and D,L-lactide and the non-biodegradable monomer may be styrene such that the polymeric nanoporous template is composed of polystyrene.

Wherein, the filler material is selected form the group consisting of silicon dioxide (SiO₂), titanium dioxide (TiO₂) and barium titanate (BaTiO₃).

Wherein, the nanocomposite material is silicon dioxide/polystyrene (SiO₂/PS) when the polymeric nanoporous template composed of polystyrene is blended with a tetraethyl orthosilicate solution, titanium dioxide/polystyrene (TiO₂/PS) when the polymeric nanoporous template is blended with a titanium(IV) isopropoxide solution, and barium titanate/polystyrene (BaTiO₃/PS) when the polymeric nanoporous template is blended with barium hydroxide dissolved in acetic acid and mixed into the titanium(IV) isopropoxide solution.

The fabrication method of nanomaterial by using a polymeric nanoporous template in accordance with the present invention has the following advantages:

(1) The polymeric nanoporous template manufactured in accordance with the present invention is composed of polymers, belonging to a soft material, and having the advantages of a simple and easy manufacture and a low cost.

(2) The block copolymer of the present invention is manufactured as a lump or a film, thus providing a broader scope of applicability.

(3) The decomposable portion of the block copolymer bulk in the present invention can be removed completely by a single step of hydrolysis to provide a porous polymeric nanoporous template.

(4) The arrageability of polymers is used for removing the decomposable portion to obtain a nanoporous polymer template with a large-range arrangement, specific structure and excellent regularity, and the nanoporous polymer template is very useful for designing devices.

(5) The present invention not just manufactures nanomaterials having different nanostructures, but also the block copolymer bulks, polymeric nanoporous templates and nanocomposite materials obtained from the manufacturing process can be applied to the manufacture or property measurement of other devices depending on their functions.

### BRIEF DESCRIPTION OF THE DRAWINGS

FIG. 1 is a flow chart of a fabrication method of a nanomaterial by using a polymeric nanoporous template in accordance with an embodiment of the present invention;

FIG. 2 is a flow chart of a fabrication method of a nanomaterial by using a polymeric nanoporous template in accordance with several preferred embodiments of the present invention;

FIG. 3 is a schematic view of an experiment procedure of synthesizing a block copolymer by PS-PLLA in accordance with the present invention;

FIG. 4 shows TEM images of the mass-thickness contrast of diblock copolymer bulks dyed with ruthenium tetroxide in accordance with the present invention;

FIG. 5A shows a TEM image of a PS-PLLA diblock copolymer bulk of the present invention;

FIG. 5B shows a TEM image of a SiO₂/PS nanocomposite material of the present invention;

FIG. 6A shows a TEM image of a TiO₂/PS nanocomposite material of the present invention;

FIG. 6B shows an EDS element analysis chart of the TiO₂/PS nanocomposite material of the present invention;

FIG. 7A shows a TEM image of a BaTiO3/PS nanocomposite material of the present invention;

FIG. 7B shows an EDS element analysis chart of the BaTiO₃/PS nanocomposite material of the present invention;

FIGS. 8A to 8C show SEM images of SiO₂/PS nanocomposite materials manufactured by a PS-PLLA polymeric nanoporous template having a helix nanostructure in accordance with the present invention;

FIGS. 9A to 9C show SEM images of SiO₂/PS nanocomposite materials manufactured by a PS-PDLA polymeric nanoporous template having a gyroid nanostructure in accordance with the present invention;

FIG. 10 shows a SPM image of a polymeric nanoporous template after a PLLA portion of a block copolymer film is degraded in accordance with the present invention;

FIG. 11 shows a SPM image of filling an electrically conductive polymer into holes of a polymeric nanoporous template in accordance with the present invention; and

FIG. 12 shows a SEM image of filling an electrically conductive polymer into holes of a polymeric nanoporous template in accordance with the present invention.

### DETAILED DESCRIPTION OF THE PREFERRED EMBODIMENTS

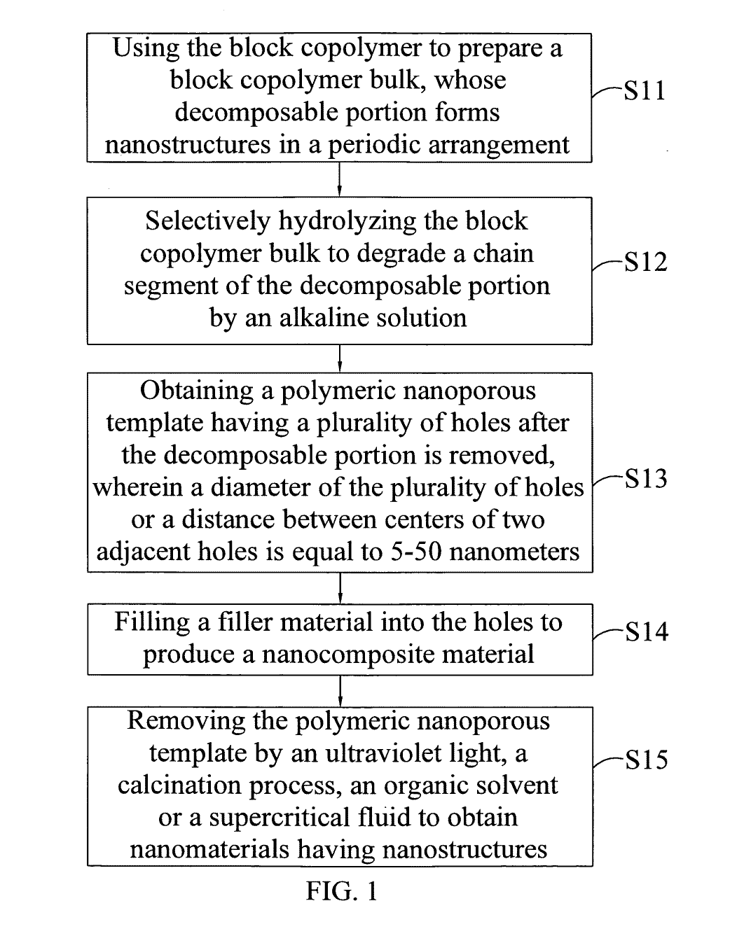

With reference to FIG. 1 for a flow chart of a fabrication method of nanomaterials by using polymeric nanoporous templates in accordance with an embodiment of the present invention, the fabrication method comprises the following steps. In Step S11, a block copolymer formed by polymerizing at least one decomposable monomer and at least one undecomposable monomer is provided, and then is used to prepare a block copolymer bulk, whose decomposable portion forms a plurality of nanostructures in a periodic arrangement. In Step S13, the block copolymer bulk is hydrolyzed selectively by an alkaline solution to degrade a chain segment of the decomposable portion to obtain polymeric nanoporous templates having a plurality of holes after the decomposable portion is removed, and the diameter of the holes or the distance between centers of two adjacent holes is equal to 5˜50 nm. In Step S14, a filler material is filled into the holes to produce a nanocomposite material having the plurality of nanostructures as described above. In Step S15, the polymeric nanoporous templates of the nanocomposite material are removed by an ultraviolet light, a calcination process, an organic solvent or a supercritical fluid to obtain a plurality of nanomaterials having the plurality of nanostructures. In addition, Step S12 may further comprise dissolving the block copolymer powders into a solvent, and voltalizing the solvent to produce a block copolymer bulk. Step 14 may be executed by a so-gel process, an electrochemical synthesis or a chemical deposition to fill the selected filler material into the plurality of holes.

The decomposable monomer used in this method may be a chiral molecule. Each of the plurality of nanostructures is a sphere, cylinder, lamella, bicontinuous (or gyroid), perforated layer or helix structure, and the shape of the nanostructure can be controlled by a volume fraction of the block copolymer bulk. If the nanostructure is in the shape of a sphere, then the overall nanostructure may be a body cubic structure in a periodic arrangement. If the nanostructure is in the shape of a cylinder, then the overall nanostructure may be in a hexagonal close-pack cylinder structure (also known as a hexagonal cylinder structure) in a periodic arrangement. In addition, the filler material can be a ceramic material, a polymer material, a metal material or any combination of the above, such that the produced nanocomposite material is composed of ceramic/polymer, metal/polymer or polymer/polymer. The nanomaterial comprises an organic/inorganic composite nanomaterial or an inorganic nanomaterial.

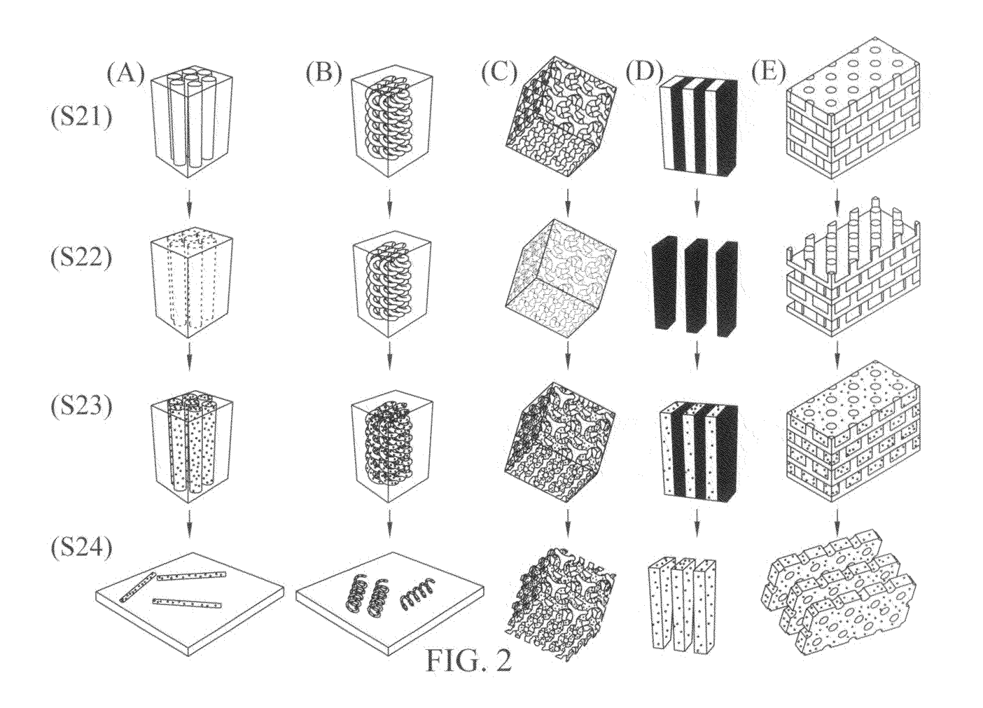

With reference to FIG. 2 for a flow chart of a fabrication method of nanomaterials by using a polymeric nanoporous template in accordance with several preferred embodiments of the present invention, FIGS. S21-A to S21-E show a poly(styrene)-b-poly(L-lactide) (PS-PLLA), poly(styrene)-b-poly(D-lactide) (PS-PDLA) or poly(styrene)-b-poly(D,L-lactide) (PS-PLA) block copolymer bulk manufactured by a PS-PLLA, PS-PDLA or PS-PLA block copolymer formed by a polymerization of a L-lactide (L-LA), D-lactide (D-LA) or D,L-lactide biodegradable monomer with a styrene non-biodegradable monomer. The PLLA, PDLA or PLA having a chiral and biodegradable portion forms a different nanostructure according to a different volume fraction of PLLA, PDLA or PLA and styrene as shown in the figure, such as a cylinder (as shown in FIG. S21-A), a helix (as shown in FIG. S21-B), a gyroid (as shown in FIG. S21-C), a lamella (as shown in FIG. S21-D) and a perforated layer (HPL) (as shown in FIG. S21-E).

In FIGS. S22-A to S22-E, alkaline solutions are used for removing PLLA, PDLA or PLA polymer composite portions by a hydrolysis to produce a polymeric nanoporous template having a plurality of holes, wherein the shape of the holes is the same as the shape of the original PLLA, PDLA or PLA, and the diameter of the holes or the distance between centers of two adjacent holes are equal to 5˜50 nm. In FIGS. S23-A to S23-E, the concept of nanoreactor is integrated, and a sol-gel process, an electrochemical synthesis or a chemical deposition is used for filling a ceramic, metal or polymer filler material to produce a nanocomposite material in various microstructures composed of ceramics/polymer, metal/polymer or polymer/polymer. In FIGS. S24-A to S24-E, an ultraviolet (UV) light is used for removing the polymer template to obtain an amorphous nanomaterial, or a calcination process is used for removing the polymeric nanoporous template to obtain crystalline nanomaterials.

The manufacturing method of the said block copolymer PS-PLLA may be as follows (and the method of producing the block copolymers, PS-PDLA and PS-PLA is used with the same principle as described below). To achieve the production of the block copolymer having a biodegradable portion, manufacturers can use the characteristics of a synthesis having a double headed initiator and an atom transfer radical polymerization (living polymerization), and the variety of selections of monomers to polymerize the biodegradable monomers (esters) and non-biodegradable monomers to provide a block copolymer system having a biodegradable portion. Therefore, the living polymerization method is used for synthesizing a series of polyester biodegradable diblock copolymers, and the synthesis method is divided into two sequential living polymerizations. Firstly, an atom transfer radical polymerization method is adopted to prepare a styrene polymer with a narrow molecular weight distribution, and then a living ring opening polymerization is adopted to achieve the polymerization effect.

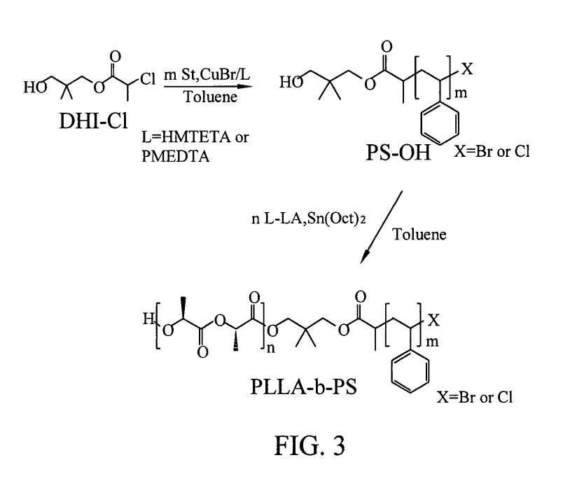

With reference to FIG. 3 for a schematic view of an experiment proceduce of synthesizing a block copolymer by using PS-PLLA as an example in accordance with the present invention, DHI₄—Cl (HOCH₂CH(CH₃)₂CH₂OC(═O)CHCl(CH₃) is used as an initiator to perform an atom transfer radical polymerization for the styrene monomers and copper bromide (CuBr) is added into the reaction system as a catalyst, and hexamethyltriethylenetetramine (HMTETA) or pentamethyldiethylenetriamine (PMDETA) acts as a ligand. After the styrene monmers are added, a polymerization takes place at a temperature of 110°. Until the solution turns into a solid state and becomes immobile, an ice bath is used for cooling the reaction system instantaneously to terminate the reaction, and toluene is used for dissolving the polymer, and silicon gel is used to remove extra copper ions. Now, the bluish green solution turns into a clear colorless thick solution, and then methanol is added to extract the styrene polymer and remove extra monomers and ligands to complete the purification and extraction processes. Until methanol is removed by baking, a second-stage laticide monomer living ring opening polymerization takes place. The second-stage living polymerization mainly uses PS-OH synthesized in the first stage as an initiator, L-laticide (L-LA, which is an ester) as a monomer, and stannous octoate (Sn(Oct)₂) as a catalyst. A small amount of toluene acting as a solvent is added to increase the uniformity of the reaction system, and the reaction takes place at a temperature of 110° for approximately 3˜5 hours to complete the living ring opening polymerization. L-lactide monomers will be connected to PS-OH, and then the living ring opening polymerization is carried out to form a PS-PLLA block copolymer. The reaction is terminated after a cooling process by an ice bath takes place, and then dichloromethane is added to dissolve PS-PLLA, and then methanol is used for the purification and extraction processes, and finally PS-PLLA polymer powders are obtained after a baking process takes place.

A gel permission chromatography (GPC) is used for measuring the molecular weight and the molecular weight distribution of the synthesized PS. Since there any be a discrepancy between the molecular weight measured by the GPC and the actual molecular weight up to several times, therefore a nuclear magnetic resonance (NMR) is adopted to measure the molecular weight of the chain segments of the polyester, but the measurement of the molecular weight distribution of the copolymer still relies on the result measured by the GPC.

The preparation method of a PS-PLLA diblock copolymer bulk and the identification of its nanostructure as shown in FIG. 2 may be implemented as follows (and the preparation method of PS-PDLA and PS-PLA block copolymer bulks is adopted with the same principles as described below). Dichloromethane used as a solvent and a block copolymer are used for producing a block copolymer solution with 10% by weight, and the solvent is volatilized at room temperature to form a block copolymer bulk with a microphase separation. Since the block copolymer solution induces a formation of crystals due to the volatilization of the solvent to result in a morphological change, therefore a differential scanning calorimeter (DSC) is used for heating the block copolymer bulk formed by solution casting from dichloromethane (CH₂Cl₂) solution (10 wt % of PS-PLLA or PS-PDLA or PS-PLA) at room temperature. The dry samples are first heated to the maximum annealing temperature, Tₘₐₓ=185° C. for three minutes to eliminate the lactide polymer crystalline residues formed during the preparation procedure, and the temperature is dropped to −50° C. at a cooling speed of 150□/min to prepare a block copolymer bulk in a microphase separation state. A microtome is used for cutting super-thin slides, such that the test plate has a thickness of tens of nanometers, and then a transmission electron microscopy (TEM) is used for the morphological observation and the analytical identification of the nanostructure. In the meantime, the result of a structural refraction of a small angle X-ray scattering (SAXS) is adopted to verify the result observed by the TEM. The ordered microstructure of the block copolymer bulk can be identified by a relative position of a d-spacing of a small angle X-ray scattering spectrum measured by the Bragg's law of refraction. If the ordered microstructure disappears, then the refraction spectrum shows that a spectrum of an order-less melting state.

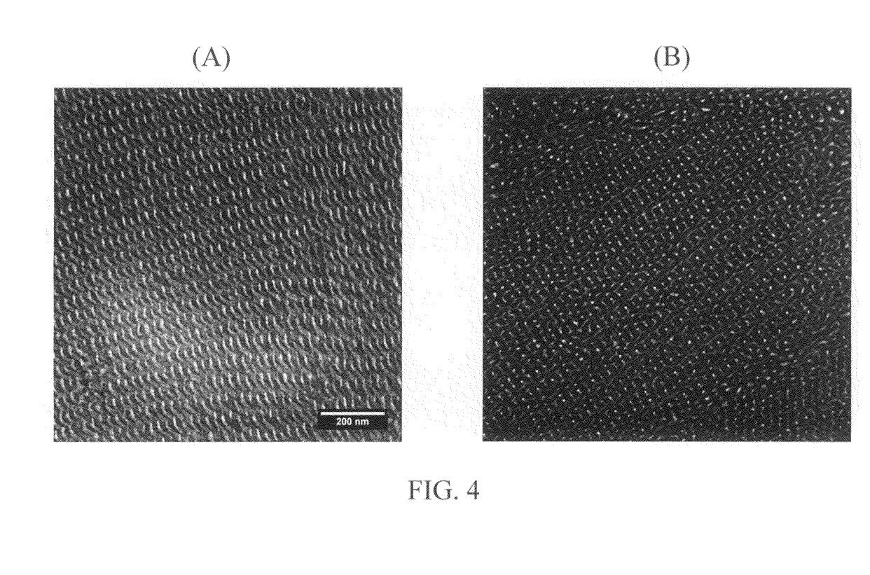

The morphological observation made by the TEM adopts the mass-thickness contrast of a dye. For example, as shown in FIG. 4, the images of mass-thickness contrast of the diblock copolymer bulk microphase separation structure system dyed with ruthenium tetroxide (RuO₄) shows different microphase separation structures, comprising a helix microphase separation structure as shown in FIG. 4A, and a gyroid microphase separation structure as shown in FIG. 4B.

In the method of preparing a polymeric nanoporous template composed of PS only as shown in FIG. 2, a bulk of a polyester biodegradable block copolymer system is used due to a component thereof is a biodegradable material, and a polyester/polymer ester group hydrolysis reaction is used for decomposing the decomposable areas to produce a nanoscale polymeric nanoporous template. The PS-PLLA block copolymer bulk gone through a high-temperature denucleation is put into a degradation liquid (Vol %, 0.5N sodium hydroxide:methanol=7:10), at a constant temperature of 50° and stirred for 7 days, and stirred and submerged into a cleaning liquid (Vol %, methanol:water=1:1) for one day, and then removed and baked dry. Now, we can visually observe that the block copolymer bulk is changed from the original transparent lump into a white opaque bulk, which shows that the PLLA portion is degraded by the alkaline liquid, and the remaining portion is the porous polymeric nanoporous template composed of PS only. A complete degradation of PLLA can be confirmed by a NMR measurement.

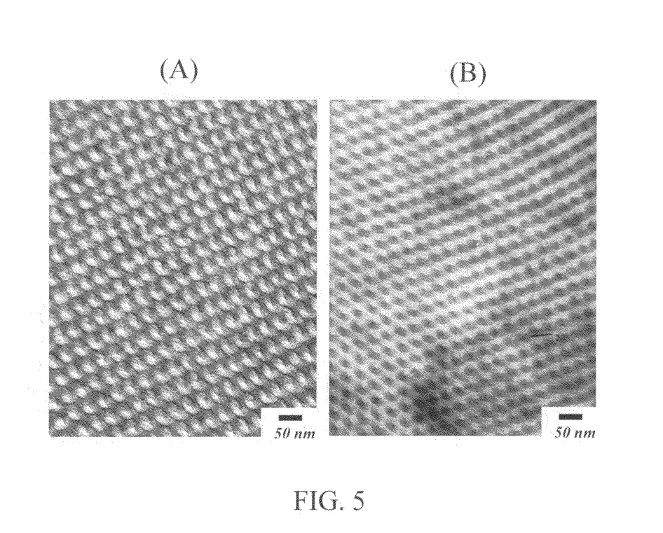

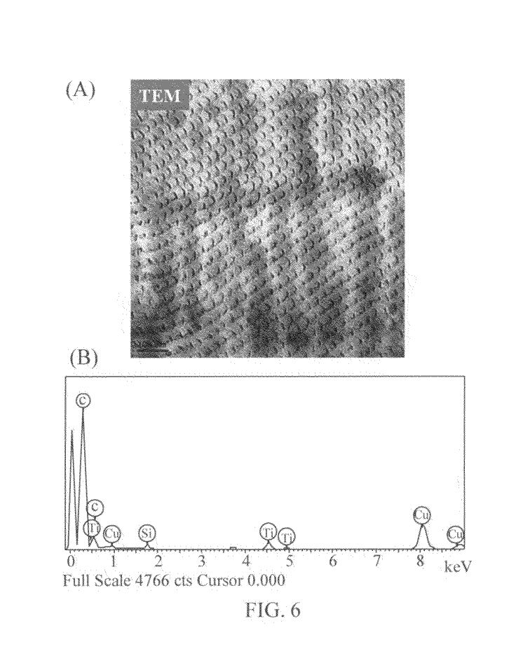

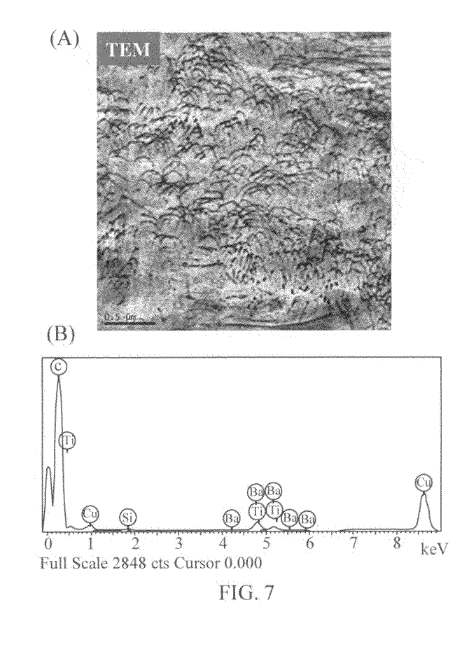

The nanocomposite material with different compositions such as silicon dioxide (SiO₂)/PS, titanium dioxide (TiO₂)/PS or barium titanate (BaTiO₃)/PS as shown in FIG. 2 is produced by the following methods: (1) The PS polymeric nanoporous template is put into a tetraethyl orthosilicate (TEOS) solution, and then stirred at room temperature for 3 days in order to mixed uniformly, and then put into an oven of 50° containing saturated water vapor, and set still for 5 days. Until the solution forms a glass-like substance, a SiO₂/PS nanocomposite material is produced. (2) Similarly, the PS polymeric nanoporous template is put into titanium(IV) isopropoxide (TTIP) solution, and then stirred at room temperature for 3 days to mixed uniformly, and then put into an oven of 50° containing saturated water vapor, and set still for 5 days. Until the solution forms a glass-like substance, a TiO₂/PS nanocomposite material is produced (3) Similarly, barium hydroxide (Ba(OH)₂) is dissolved in acetic acid, and the solution is mixed into TTIP solution, and then stirred at room temperature for 3 days to mixed uniformly, and then put into an oven of 50° containing saturated water vapor, and set still for 5 days. Until the solution forms a glass-like substance, a BaTiO₃/PS nanocomposite material is produced. A microtome is used for slicing super thin slices, such that the test plate has a thickness of tens of nanometers, and then a transmission electron microscopy (TEM) is used for the morphological observation as shown in FIG. 5, wherein FIG. 5A shows a TEM observation of a PS-PLLA slice with a PS portion dyed with RuO₄, and thus the dark portion is the main phase of PS, and the white portion is PLLA; FIG. 5B shows a TEM observation of a SiO₂/PS slice without being dyed by RuO₄, and thus the main phase of PS is the white area, and SiO₂ has electronic clouds of a higher density and shows a darker color under the TEM, and thus the comparison of the template after/before being filled shows that the holes of the polymeric nanoporous template has been filled by SiO₂ already. FIGS. 6A and 6B show respectively a TEM image and an energy Dispersive X-ray spectrometer (EDS) element analysis chart of polymeric nanoporous templates filled with TiO₂ of the present invention; and FIGS. 7A and 7B show a TEM image and an energy Dispersive X-ray spectrometer (EDS) element analysis chart of polymeric nanoporous templates filled with BaTiO₃ respectively, and we can observe that TiO₂ and BaTiO₃ have been filled into the nanoholes.

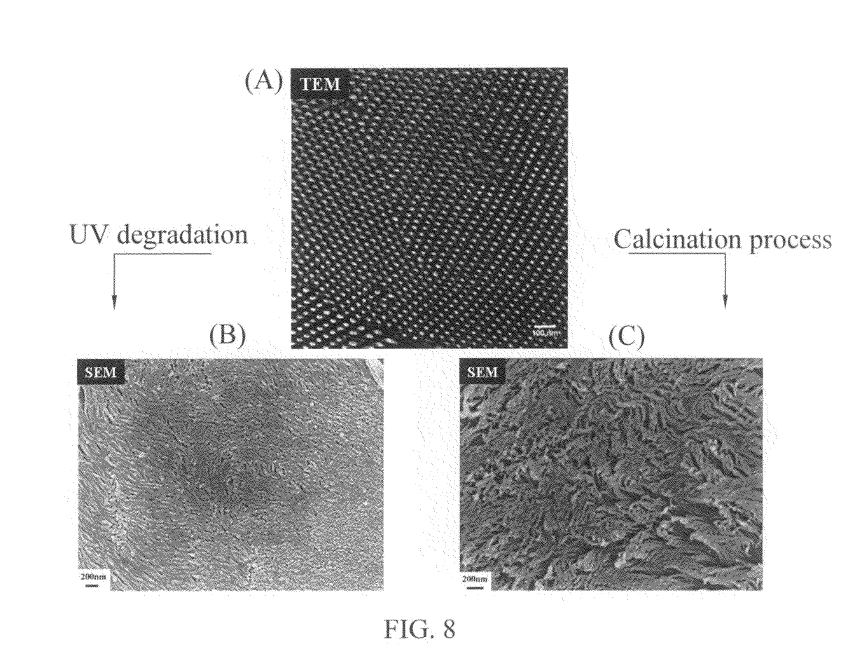

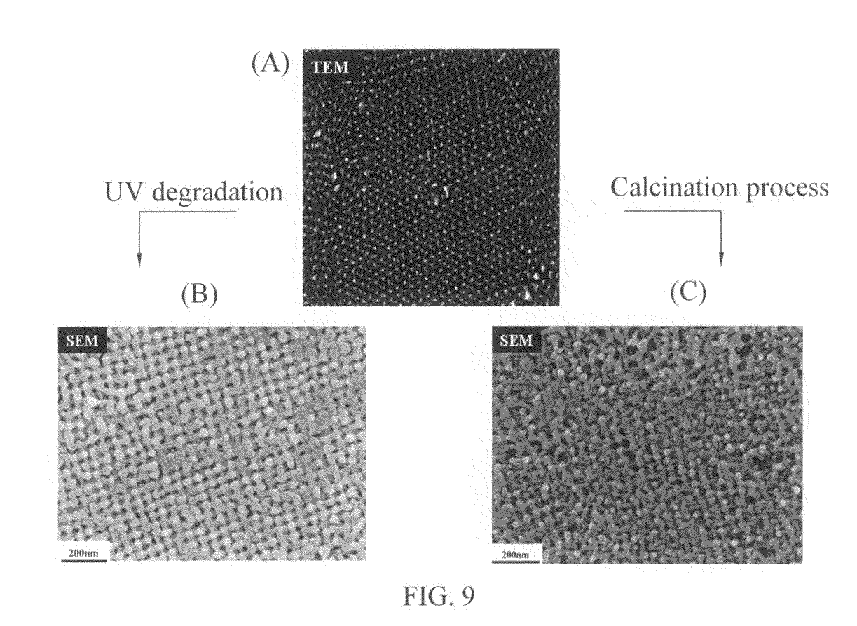

The nanomaterial is prepared by a sol-gel process as shown in FIG. 2, and an ultraviolet (UV) light is used for removing the PS polymeric nanoporous template to obtain an amorphous inorganic nanomaterial, or a calcination process (550°) is used for removing the polymer template to obtain a crystalline inorganic nanomaterial. From a scanning electron microscopy (SEM) observation for analyzing and identifying a microstructure as shown in FIG. 8, SEM images of SiO₂/PS nanocomposite materials having a helix nanostructure and manufactured by a PS-PLLA polymeric nanoporous template are shown, wherein FIG. 8A shows the TEM micrographs of RuO₄ staining PS-PLLA gyroid nanostructures, and FIG. 8B shows an amorphous inorganic nanohelices formed after the SiO₂/PS nanocomposite material of the PS template is degraded by the UV light, and FIG. 8C shows a crystalline inorganic nanohelices formed after the SiO₂/PS nanocomposite material of the PS template is degraded by a calcination process. With reference to FIG. 9 for SEM images of SiO₂/PS nanocomposite materials manufactured by a PS-PDLA polymeric nanoporous template having a gyroid nanostructure in accordance with the present invention, wherein FIG. 9A shows the TEM micrographs of RuO₄ staining PS-PDLA gyroid nanostructures, and FIG. 9B shows an amorphous interpenetrating network structure formed after the SiO₂/PS nanocomposite material of the PS template is degraded by the UV light, and FIG. 9C shows a crystalline network structure formed after the SiO₂/PS nanocomposite material of the PS template is degraded by a calcination process.

The present invention adopts the aforementioned bottom-up method to synthesize a polymeric nanoporous template with a variety of structures, not just capable of filling SiO₂, TiO₂ and BaTiO₃ only, but also capable of filling other different filler materials such as polymers, metals, or functional materials, for producing various different functional nanocomposite material. After the polymeric nanoporous template is removed, nanomaterials in various different shapes can be obtained. With such technical platform, a series of fantastic nanomaterials can be developed by a combination of the nanostructure and different filler materials. Obviously, the present invention is a novel and useful technology.

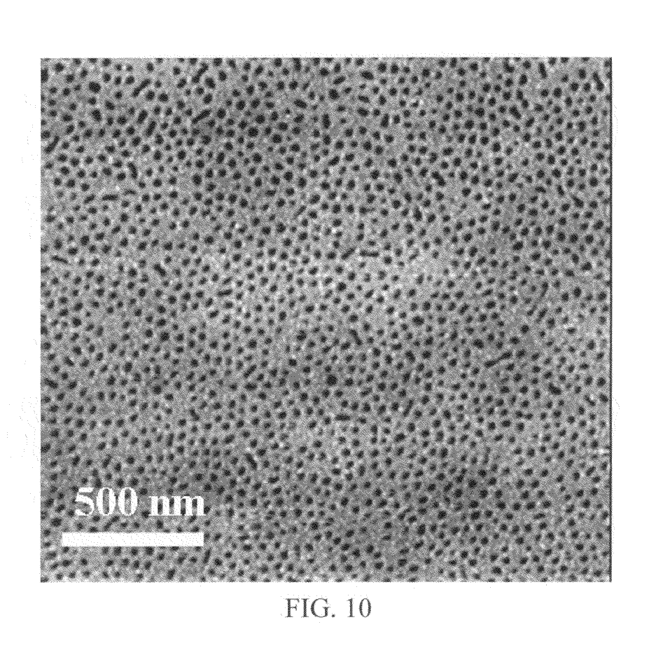

In addition, the present invention is capable of producing a block copolymer film by a block copolymer besides a block copolymer bulk, and further manufacturing a polymeric nanoporous template in the shape of a porous film. For example, PS-PLLA is used for the manufacture in a manufacturing method as follows: 1 wt % of a block copolymer (PS-PLLA) solution is used for forming a film on an indium-tin oxide (ITO) conductive substrate by a spin coating method. By controlling the solvent and the volatilization speed appropriately, we can produce a block copolymer film having a nano cylindrical microstructure with a thickness of approximately 70 nm and regularly arranged in a vertical direction. To increase the adhesion of the block copolymer film with the inorganic conductive substrate and prevent the block copolymer film from being detached during a later process of degrading PLLA by a wet method, organic molecules on the surface of the ITO substrate are used for a chemical modification, such that the adhesion force at organic and inorganic interfaces can be enhanced. The prepared block copolymer film is submerged into an aqueous sodium hydroxide (NaOH)/methanol solution to remove the PLLA chain segments, so as to obtain a polymeric nanoporous template having holes of approximately 15˜20 nm. In FIG. 10, an image obtained by a scanning probe microscopy (SPM) after the PLLA portion of the block copolymer film is degraded.

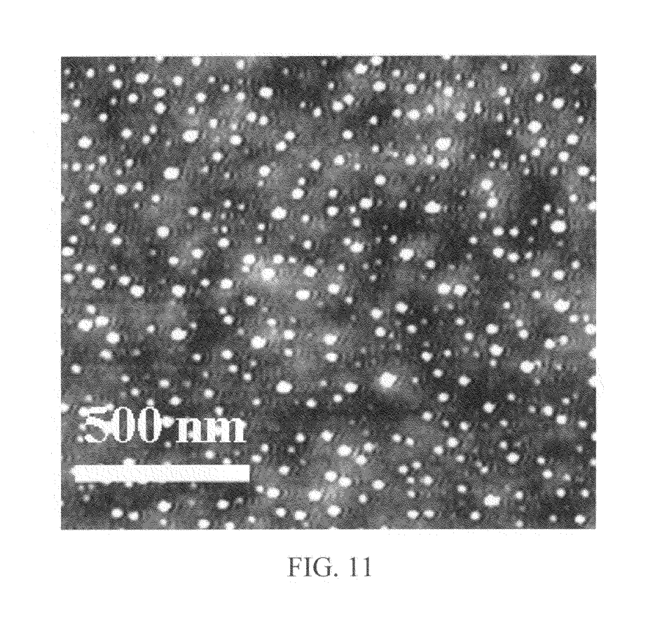

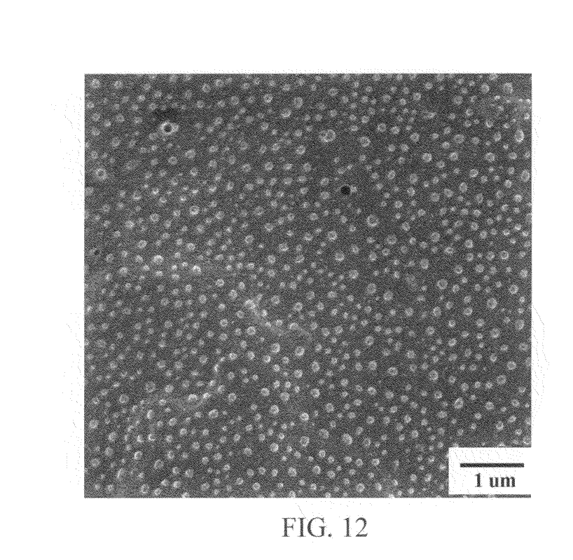

The electrochemical synthesis is adopted again to fill the filler material into the holes of the polymeric nanoporous template to produce a nanocomposite film. In the manufacturing method, the filler material is a conductive polymer (which is aniline in this embodiment), and monomers of the conductive polymer (aniline) are dissolved in dilute sulfuric acid, and then a tri-electrode (working, contact and reference electrodes) method is adopted, wherein the ITO substrate coated with a template having holes acts as a working electrode, a platinum electrode acts as a contact electrode and an Ag/AgCl electrode acts as a reference electrode, and a reaction potential is applied in an electrolysis bath to diffuse the polymer monomers, and an electro-chemical reaction takes place on the conductive substrate to perform electrical polymerization reaction. To diffuse the electrolyte into organic nanoholes, the experiment flow adds a tertiary alcohol as a surfactant, and then a capillary action force drives the aniline electrolyte to diffuse and enter into the holes for the electrical polymerization reaction, and the experimental result shows that it is difficult to control the uniformity of aniline to be grown in different holes if the speed of the electrical polymerization reaction is too fast, and thus the final distribution of the conductive polymers is affected. With a pulse electroplating method together with a control of the micro current, the conductive polymers can be deposited uniformly into the organic nanoholes of PS to produce a conductive polymer/polymer nanocomposite film. FIGS. 11 and 12 show images of conductive polymers filled into the holes of the polymeric nanoporous template, and the images are taken through by a scanning probe microscopy (SPM) and a scanning electron microscopy SEM.

While the invention has been described by means of specific embodiments, numerous modifications and variations could be made thereto by those skilled in the art without departing from the scope and spirit of the invention set forth in the claims.

What is claimed is:

1. A fabrication method of a nanomaterial by using a polymeric nanoporous templatepolymeric nanoporous template, comprising the steps of:
a) preparing a block copolymer bulk by a block copolymer composed of at least one decomposable monomer and at least one undecomposable monomer polymerized with one another, and a decomposable portion of the block copolymer bulk forming a plurality of nanostructures with a periodic arrangement;
b) selectively hydrolyzing the block copolymer bulk to degrade a chain segment of the decomposable portion by an alkaline solution;
c) obtaining a polymeric nanoporous templatepolymeric nanoporous template having a plurality of holes after removing the decomposable portion, wherein a diameter of the plurality of holes or a distance between centers of two adjacent holes is equal to 5-50 nanometers;
d) filling a filler material into the plurality of holes of the polymeric nanoporous template by a so-gel process to produce a nanocomposite material comprising the plurality of nanostructures; and
e) removing the polymeric nanoporous template of the nanocomposite material by an ultraviolet light, a calcination process, an organic solvent or a supercritical fluid to obtain a plurality of nanomaterials having the plurality of nanostructures;
wherein the decomposable monomer is selected form the group consisting of L-lactide, D-lactide and D,L-lactide and the non-biodegradable monomer is styrene such that the polymeric nanoporous template is composed of polystyrene;
wherein the filler material is selected form the group consisting of silicon dioxide, titanium dioxide and barium titanate;
wherein the nanocomposite material is silicon dioxide/polystyrene (SiO₂/PS) when the polymeric nanoporous template is blended with a tetraethyl orthosilicate solution, titanium dioxide/polystyrene (TiO₂/PS) when the polymeric nanoporous template is blended with a titanium(IV) isopropoxide solution, and barium titanate/polystyrene (BaTiO₃/PS) when the polymeric nanoporous template is blended with barium hydroxide dissolved in acetic acid and mixed into the titanium(IV) isopropoxide solution.

2. The fabrication method of nanomaterials as recited in claim 1, wherein the Step a) further comprises dissolving powers of the block copolymer into a solvent, and volatilizing the solvent to prepare the block copolymer bulk.

3. The fabrication method of nanomaterials as recited in claim 2, wherein the solvent comprises dichloromethane.

4. The fabrication method of nanomaterials as recited in claim 1, wherein the decomposable monomer is a chiral molecule.

5. The fabrication method of nanomaterials as recited in claim 1, wherein the decomposable monomer comprises a biodegradable monomer, and the undecomposable monomer comprises a non-biodegradable monomer.

6. The fabrication method of nanomaterials as recited in claim 1, wherein the block copolymer bulk comprises poly(styrene)-b-poly(L-lactide) (PS-PLLA) block copolymer bulk, poly(styrene)-b-poly(D-lactide) (PS-PDLA) block copolymer bulk or poly(styrene)-b-poly(D,L-lactide) (PS-PLA) block copolymer bulk.

7. The fabrication method of nanomaterials as recited in claim 1, wherein the nanostructure comprises a sphere, cylinder, lamella, bicontinuous (or gyroid), perforated layer or helix structure.

8. The fabrication method of nanomaterials as recited in claim 7, wherein the nanostructure with the sphere structure is periodically arranged into a body cubic structure.

9. The fabrication method of nanomaterials as recited in claim 7, wherein the nanostructure with the cylinder structure is periodically arranged into a hexagonal close-pack cylinder structure.

10. The fabrication method of nanomaterials as recited in claim 7, wherein the nanostructure is controlled by a volume fraction of the block copolymer bulk.

11. The fabrication method of nanomaterials as recited in claim 1, wherein the alkaline solution comprises a sodium hydroxide/methanol solution.

12. The fabrication method of nanomaterials as recited in claim 1, wherein the Step d) further comprises using a method selected from the group consisting of an electrochemical synthesis and a chemical deposition to fill the filler material into the plurality of holes of the polymeric nanoporous template.

13. The fabrication method of nanomaterials as recited in claim 1, wherein the filler material further comprises a ceramic material, a polymer material, a metal material or any combination thereof.

14. The fabrication method of nanomaterials as recited in claim 13, wherein the polymer material comprises an electrically conductive polymer, and the electrically conductive polymer is made of a material comprising a polymer of aniline.

15. The fabrication method of nanomaterials as recited in claim 13, wherein the nanocomposite material is made of ceramics/polymer, metal/polymer or polymer/polymer.

16. The fabrication method of nanomaterials as recited in claim 1, wherein the nanomaterial comprises an organic/inorganic composite nanomaterial, an inorganic/inorganic composite nanomaterial or an inorganic nanomaterial.

17. The fabrication method of nanomaterials as recited in claim 1, wherein the ultraviolet or the calcination process is used for removing the polymeric nanoporous template composed of a polymer, and the nanomaterial so obtained is in an amorphous phase or a crystalline phase, respectively.
